(19) United States
(12) Patent Application Publication
(10) Pub. No.: US 2017/0217493 A1
(43) Pub. Date: Aug. 3, 2017

(54) ADJUSTABLE CAMBER AND CASTER BUSHING

(71) Applicant: Dana Automotive Systems Group, LLC, Maumee, OH (US)

(72) Inventors: Steven T. Byrne, Holland, OH (US); Jeremy A. Rapp, Waterville, OH (US); Scott L. Steward, Malinta, OH (US)

(21) Appl. No.: 15/420,168

(22) Filed: Jan. 31, 2017

Related U.S. Application Data
(60) Provisional application No. 62/289,391, filed on Feb. 1, 2016.

(51) Int. Cl. B62D 17/00; B62D 7/18

(52) U.S. Cl. CPC B62D 17/00; B62D 7/18; B60G 2200/46; B60G 2200/464; B60G 2200/4622; B60G 2204/61

(57) ABSTRACT

An adjustable camber and caster bushing. The bushing comprises a planar portion having a first side, a second side, an aperture and an outer perimeter. The bushing also comprises a tubular portion, which is integrally formed with and unitary with the planar portion. The tubular portion comprises an inner diameter, an outer diameter, a first end, and a second end. The inner diameter defines an aperture extending the length of the tubular portion. The inner diameter is tapered, while the outer diameter remains constant. The tubular portion also comprises a slot extending the length of the tubular portion.

### CROSS-REFERENCE TO RELATED APPLICATIONS

This application claims the benefit of U.S. Provisional Application No. 62/289,391 filed on Feb. 1, 2016, which is incorporated by reference in its entirety herein.

### FIELD OF THE INVENTION

The present invention relates to a bushing for adjusting the camber and/or caster of a steerable wheel assembly.

### BACKGROUND OF THE INVENTION

The typical vehicular steering assembly is conventionally manufactured to provide a fixed camber and caster. The amount of camber and caster is predetermined and the wheel assembly is manufactured to these predetermined values.

Camber is the angle of the wheel relative to vertical, as viewed from the front or the rear of the vehicle. If the bottom of the wheel that contacts the road leans in towards the chassis, it has negative camber; if it leans away from the vehicle, it has positive camber.

Caster is the angle to which the steering pivot axis is tilted forward or rearward from vertical. If the pivot axis is tilted backward (that is, the top pivot is positioned farther rearward than the bottom pivot), then the caster is positive; if it's tilted forward, then the caster is negative.

Due to manufacturing tolerances and changes of condition of the vehicle, such as wear and environmental factors, camber and caster adjustment is desired to provide individualized and improved handling characteristic of the vehicle. A plurality of camber and caster adjusters are available, for example strut assemblies, joint assemblies and bushings or sleeves with an eccentrically displaced hole for adjustment. Most of these adjusters require multiple parts, tools, and/or technical skills to make the necessary adjustments to the camber and caster of a vehicle.

In view of the foregoing disadvantages of the prior art, it would be advantageous to have a simple, low cost adjuster that is easy to use and that can safely and effectively adjust the camber and caster of a vehicle.

### SUMMARY OF THE INVENTION

The present invention is directed toward an adjustable camber and caster bushing. The bushing comprises a planar portion having a first side, a second side, an aperture and an outer perimeter. The bushing also comprises a tubular portion. The tubular portion is integrally formed with and unitary with the planar portion, and it is perpendicular to and extends away from the planar portion. The tubular portion comprises an inner diameter, an outer diameter, a first end, and a second end. The inner diameter defines an aperture extending the length of the tubular portion. The inner diameter is tapered, while the outer diameter remains constant. The tubular portion also comprises a slot extending the length of the tubular portion.

In accordance with the present invention, it has been discovered that the adjustable camber and caster bushing reduces the number of components and time needed to adjust the camber and caster of a vehicle steer assembly.

### BRIEF DESCRIPTION OF THE DRAWING

The above, as well as other advantages of the present invention, will become readily apparent to those skilled in the art from the following detailed description when considered in the light of the accompanying drawings in which:

FIG. 1 is a perspective side view of a steering assembly for a vehicle;

FIG. 2 is another perspective view of FIG. 1 with a view of a bushing structure;

FIG. 3 is a perspective view of a bushing structure according to the present invention;

FIG. 4 is another perspective view of the bushing structure in FIG. 3;

FIG. 5 is a cut away side view of the bushing structure in FIG. 3;

FIG. 6 is a perspective assembled view of the bushing in FIG. 3;

FIG. 7 is another perspective assembled view of the bushing in FIG. 3 in a second position;

FIG. 8 is another perspective assembled view of the bushing in FIG. 3;

FIG. 9 is a perspective assembled view of a bushing in one position;

FIG. 10 is a perspective view of the bushing in FIG. 9 removed from the assembled position;

FIG. 11 is a perspective view of the bushing in FIG. 10 rotated 90 degrees; and

FIG. 12 is a perspective reassembled view of the bushing in FIG. 11.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

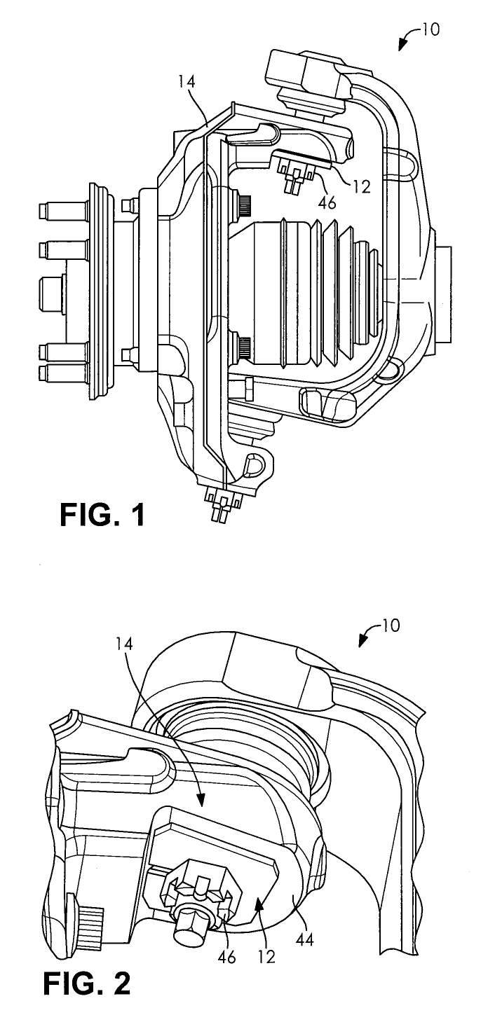

FIGS. 1 and 2 show a steering assembly 10 for use in a vehicle. As depicted in the figures, a bushing 12 is press fit into a knuckle or yoke (collectively “14”) depending on the design configuration required for the specific application. The bushing 12 allows for simple adjustment to the camber and caster of a wheel (not shown) as required, providing proper alignment and positioning of the vehicle wheel.

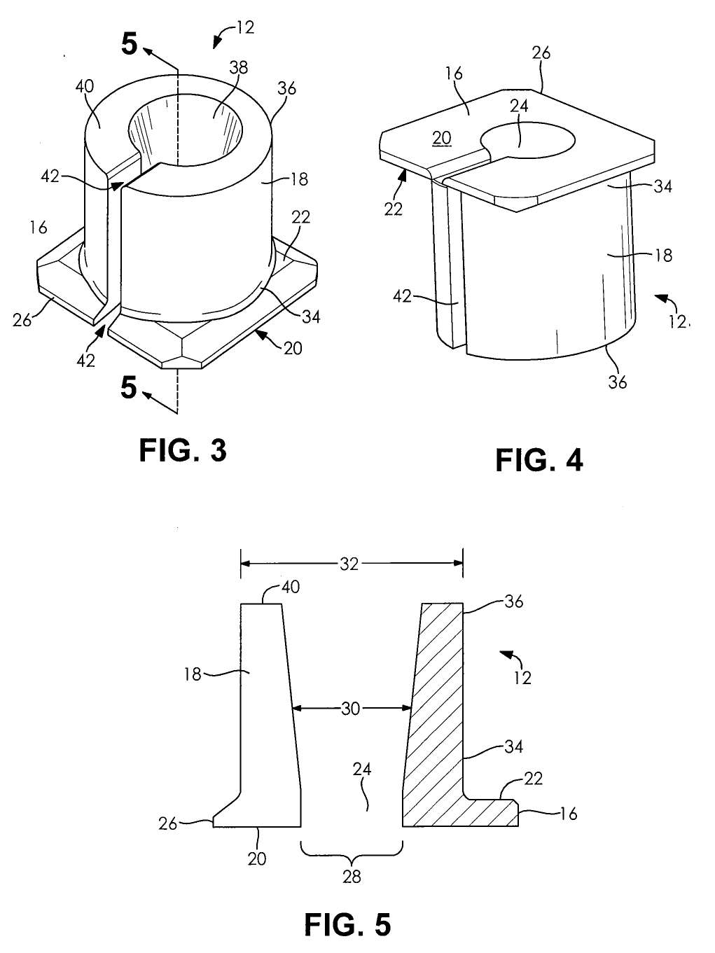

FIGS. 3, 4 and 5 each depict an adjustable camber and caster bushing 12. The bushing 12 comprises a planar portion 16 and a tubular portion 18. The planar portion 16 and the tubular portion 18 are integrally formed and unitary to create a single one-piece component.

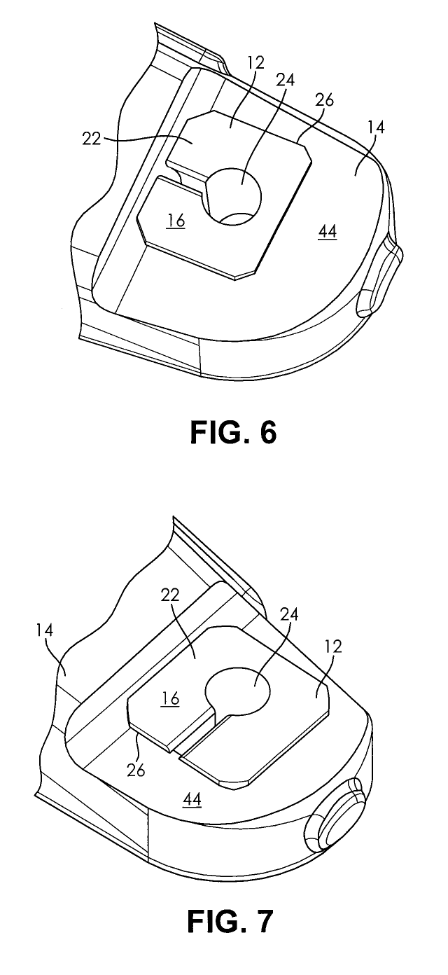

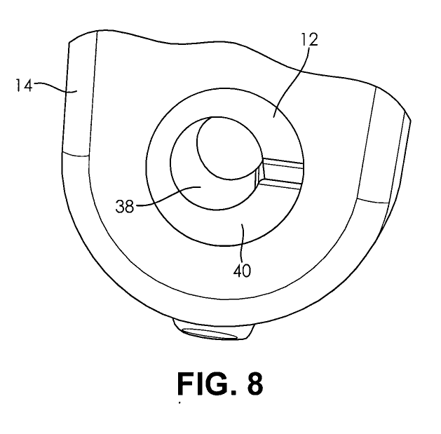

The planar portion 16 comprises a first side 20, a second side 22, an aperture 24 and an outer perimeter 26. The aperture 24 extends from the first side 20 of the planar portion 16 to the second side 22 of the planar portion 16 and maintains a constant inner diameter 28, as shown in FIG. 5. The aperture 24 is offset from a center of the planar portion 16. Specifically the aperture 24 is not located directly in the center of the planar portion 16, rather it is located off center.

As shown in FIGS. 3 and 4, the outer perimeter 26 of the planar portion 16 of the bushing 12 is generally square. Also as shown in the figures, the edges of the outer perimeter 26 of the planar portion 16 are chamfered. The chamfered edges are useful when the bushing 12 is rotated and contacts the knuckle or yoke 14, depending on the design configuration. There is a radius that must be cleared so that the bushing 12 can seat fully and a mechanical lock is achieved. It is also within the scope of the invention for the outer perimeter 26 of the planar portion 16 to be other shapes.

The tubular portion 18 is perpendicular to and extends away from the second side 22 of the planar portion 16. The tubular portion 18 comprises an inner diameter 30, an outer diameter 32, a first end 34 and a second end 36, as depicted in FIG. 5. The inner diameter 30 defines an aperture 38 extending the length of the tubular portion 18. Also as depicted in the figure, the inner diameter 30 is tapered while the outer diameter 32 remains constant the length of the tubular portion 18. The first end 34 of the tubular portion 18 directly contacts the second side 22 of the planar portion 16, and the second end 36 is at an outer edge 40 of the tubular portion 18. As depicted in the figure, the inner diameter 30 at the first end 34 of the tubular portion 18 is smaller than the inner diameter 30 of the second end 36 of the tubular portion 18.

As best illustrated in FIG. 3, the outer edge 40 wall thickness, defined by the area between the inner and outer diameters 30, 32 of the tubular portion 18 varies. As can be seen in the figure, the wall thickness gradually increases and/or decreases at different locations as can be seen along the outer edge 40 of the tubular portion 18.

The tubular portion 18 also comprises a slot 42, as depicted in the FIGS. 3 and 4. The slot 42 extends from the inner diameter 30 to the outer diameter 32, and extends the entire length of the tubular portion 18. The slot 42 also extends into and through the planar portion 16 of the bushing 12. The slot 42 is axially aligned and as shown in the figures, maintains substantially the same width in the tubular portion 18 as the planar portion 16.

The lengthwise slot 42 provided in the bushing 12 provides for a slip fit with the knuckle or yoke 14. The slot 42 also provides a mechanical locking feature by allowing expansion of the bushing 12 when a mating tapered part, such as a ball joint (not shown), is installed, and forces outward movement of the bushing 12 into the knuckle or yoke 14, depending on the design configuration. The slot 42 allows for the same bushing 12 to be used in multiple steering assemblies 10.

A method of using the adjustable camber and caster bushing 12 to align the camber and caster of a vehicle steer assembly 10 will now be described herein. The method of aligning the camber and caster of a vehicle steer assembly 10 uses an integrally formed, one-piece bushing 12 comprising a planar portion 16 and a tubular portion 18.

The tubular portion 18 is perpendicular to and extending away from a second side 22 of the planar portion 16. The planar portion 16 and the tubular portion 18 have an aperture 24, 38 extending the length of the bushing 12. The bushing 12 also has a slot 42 that extends the length of the bushing 12.

The method of aligning the camber and caster of a vehicle steer assembly 10 includes fitting the bushing 12 into an aperture (not shown) in a knuckle or yoke 14. A first side 20 of the planar portion 16 is parallel with a planar surface 44 of the knuckle or yoke 14 when the bushing 12 is inserted into the steering assembly 10, as depicted in FIGS. 6 and 7. Once the bushing 12 is in place in the knuckle or yoke 14, a ball joint is inserted in the aperture 24, 38 of the bushing 12. A nut 46 is then placed on the ball joint post and tightened to hold the components in place, and to provide an initial or first camber and caster alignment.

A reading, or measurement, of the initial camber and caster is taken and the settings are calculated to determine if they are correct for the particular application, or if any adjustment is needed to provide a desired camber and caster alignment setting;

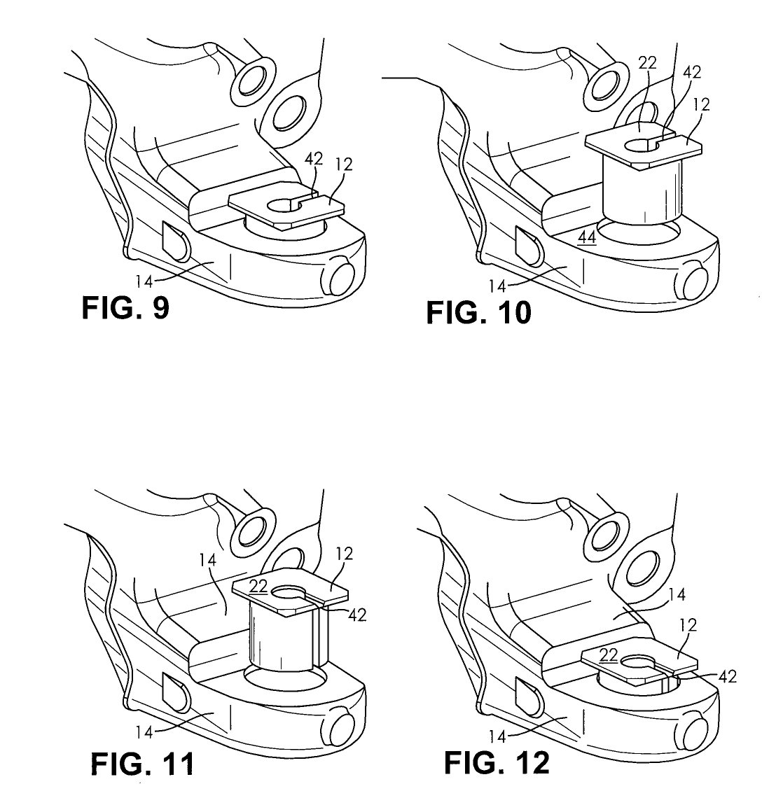

As depicted in FIG. 9-12, if a further adjustment is needed, the nut 46 is loosened and the ball joint is removed from the bushing 12. The bushing 12 can then be removed and rotated from its original position. The one piece bushing planar portion 16 and tubular portion 18 are rotated together, not incrementally of each other.

The bushing 12 can be rotated 90 degrees from its original position and fitted back into the aperture in the knuckle or yoke 14. The ball joint is again placed into the bushing 12 and tightened to provide a second angle for camber and caster alignment.

The above steps can be repeated again to rotate the bushing 12 180 degrees from its original position, to provide a third angle for camber and caster alignment. The above steps can be repeated yet again, if needed, to rotate the bushing 12 270 degrees from its original position, to provide a fourth angle for camber and caster alignment.

As previously discussed, the bushing 12 can be inserted in one position, but if the camber/caster of the steering assembly 10 needs to be adjusted, the bushing 12 can be removed, rotated and replaced back into the aperture of the knuckle or yoke 14. Because of the different wall thicknesses of the tubular portion 18 and the angle of the tapered inner diameter 30 of the tubular portion 18 of the bushing 12, each rotation incrementally changes the camber/caster to tilt the vehicle wheel in or out. The simple one piece design allows for easily making four different camber/caster adjustments, without having to refer to a manual to determine adjustment increments.

This simple design also provides a secure mechanical lock between the components. Locking is achieved by a mating tapered component, for example a ball joint, that when inserted in the bushing 12 causes expansion due to the tightened ball joint being pulled in the bushing 12. This causes the slot 42 to open and the outer diameter 32 of the bushing 12 to expand and lock into the knuckle or yoke 14 bore. Other designs have multiple parts that must have anti rotational features that, if loosened, allows the camber/caster adjustment to be lost. This design, if loosened, will not cause a loss in the camber/caster adjustment.

In accordance with the provisions of the patent statutes, the present invention has been described in what is considered to represent its preferred embodiments, however, it should be noted that the invention can be practiced otherwise than as specifically illustrated and described without departing from its scope or spirit.

What is claimed is:

1. An adjustable camber and caster bushing, comprising:
a planar portion, said planar portion comprising a first side, a second side, an aperture and an outer perimeter; and
a tubular portion integrally formed with and unitary with said planar portion, said tubular portion is perpendicular to and extending away from said second side of said planar portion, said tubular portion comprising an inner diameter, an outer diameter, a first end and a second end, wherein said inner diameter defines an aperture extending the length of said tubular portion and said inner diameter is tapered, said outer diameter is constant, said first end of said tubular portion directly contacts said second side of said planar portion and said second end is at an outer edge of said tubular portion, said tubular portion also comprising a slot.

2. An adjustable camber and caster bushing according to claim 1, wherein said outer perimeter of said planar portion is square shaped.

3. An adjustable camber and caster bushing according to claim 1, wherein said aperture of said planar portion extends from said first side to said second side and maintains a constant inner diameter.

4. An adjustable camber and caster bushing according to claims 1, wherein said aperture is offset from a center of said planar portion.

5. An adjustable camber and caster bushing according to claim 1, wherein said first side of said planar portion is parallel with a planar surface of a knuckle or yoke.

6. An adjustable camber and caster bushing according to claim 1, wherein said outer perimeter of said planar portion comprises chamfered edges.

7. An adjustable camber and caster bushing according to claim 1, wherein an inner diameter of said first end of said tubular portion is smaller than an inner diameter of said second end of said tubular portion.

8. An adjustable camber and caster bushing according to claim 1, wherein said slot extends the length of said tubular portion and into said planar portion.

9. An adjustable camber and caster bushing according to claim 1, wherein a thickness of a wall defined by the area between said inner diameter and said outer diameter of said tubular portion varies.

10. A method of aligning the camber and caster of a vehicle steer assembly using an integrally formed, one-piece bushing comprising a planar portion and a tubular portion, said tubular portion is perpendicular to and extending away from a second side of said planar portion, said planar portion and said tubular portion comprise an aperture extending the length of said bushing, the method comprising the steps:
fitting said bushing into an aperture in a knuckle or yoke;
inserting a ball joint through said aperture in said bushing;
tightening said ball joint with a nut to hold said ball joint and said bushing in place and provide a first angle for camber and caster alignment;
reading the initial camber and caster settings and calculating the adjustment, if any, needed to provide a desired camber and caster alignment setting;
if adjustment needed, loosening said nut and removing said ball joint;
removing said bushing and rotating together, said bushing planar portion and tubular portion, 90 degrees from its original position, replacing said bushing into said aperture in said knuckle or yoke, inserting said ball joint through said bushing and tightening said ball joint to provide a second angle for camber and caster alignment.

11. A method of aligning the camber and caster of a vehicle steer assembly according to claim 10, wherein removing said bushing and rotating together, said bushing planar portion and tubular portion, 180 degrees from its original position, replacing said bushing into said aperture in said knuckle or yoke, inserting said ball joint through said bushing and tightening said ball joint to provide a third angle for camber and caster alignment.

12. A method of aligning the camber and caster of a vehicle steer assembly according to claim 10, wherein removing said bushing and rotating together, said bushing planar portion and tubular portion, 270 degrees from its original position, replacing said bushing into said aperture in said knuckle or yoke, inserting said ball joint through said bushing and tightening said ball joint to provide a fourth angle for camber and caster alignment.
